(19) United States
(12) Patent Application Publication
(10) Pub. No.: US 2005/0036602 A1
(43) Pub. Date: Feb. 17, 2005

(54) System and method for auto sensing and provisioning two or four wire mode on a communications line with rate adaptation

(75) Inventors: Jeff Smith, Flower Mound, TX (US); Michael Joseph Mezeul, Allen, TX (US); Ross Alexander Jamieson, Plano, TX (US)

Correspondence Address: HAYNES AND BOONE, LLP, 901 MAIN STREET, SUITE 3100, DALLAS, TX, 75202, US

(73) Assignee: Covaro Networks, Inc., Richardson, TX (US)

(21) Appl. No.: 10/917,590

(22) Filed: Aug. 13, 2004

Related U.S. Application Data
(60) Provisional application No. 60/495,399, filed on Aug. 15, 2003.

(51) Int. Cl. H04M 11/00; H04M 7/00; H04M 1/00; H04M 3/00

(52) U.S. Cl. 379/345

(57) ABSTRACT

A system and method for sensing and provisioning two or four wire mode for a communications link are provided. In one example, the method includes attempting to train a base wire pair associated with a base port for two-wire mode. If the two-wire mode training is unsuccessful, an unassigned port associated with a first wire pair is identified and the base and unassigned ports are configured for four-wire mode. An attempt is made to train the base and first wire pairs for four-wire mode. If the four-wire mode training is successful, a four-wire service is established using the base and first wire pairs.

### CROSS-REFERENCE

This application claims priority from U.S. Provisional Patent Application Ser. No. 60/495,399, filed on Aug. 15, 2003, and entitled AUTO SENSING AND PROVISIONING TWO OR FOUR WIRE MODE ON AN SHDSL LINE WITH RATE ADAPTATION, which is hereby incorporated by reference in its entirety.

### BACKGROUND

Some communications interfaces, such as a symmetric high-speed digital subscriber line (SHDSL) interface, may be configured in either a two-wire 2.3 MB/s or four-wire 4.6 MB/s configuration. Typically, each end of a connection is wired specifically for each mode and the equipment is then manually configured (e.g., provisioned) to operate at the desired service rate. If the wiring and provisioning do not match, the service does not operate. The manual provisioning introduces complexity into the configuration process and requires that field personnel performing the provisioning understand the process and how to properly wire and configure each port associated with a wire pair.

Accordingly, what is needed is a system and method for addressing these and similar issues.

### BRIEF DESCRIPTION OF THE DRAWINGS

FIG. 1 is a flowchart of one embodiment of a method for automatically sensing and provisioning a two-wire or four-wire line.

FIG. 2a is a diagram of an exemplary system within which the method of FIG. 1 may be implemented.

FIG. 2b is a diagram of an exemplary network within which the system of FIG. 2a may be implemented.

FIG. 3 is a flowchart of one embodiment of a method for automatically sensing and provisioning two-wire or four-wire mode.

FIG. 4 is a flowchart of one embodiment of a method for automatic rate adaptation for wire pairs in four-wire mode.

### DETAILED DESCRIPTION

This disclosure relates generally to communications systems and, more particularly, to providing a system and method for auto sensing and provisioning two or four wire mode on a communications line, such as a SHDSL line. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

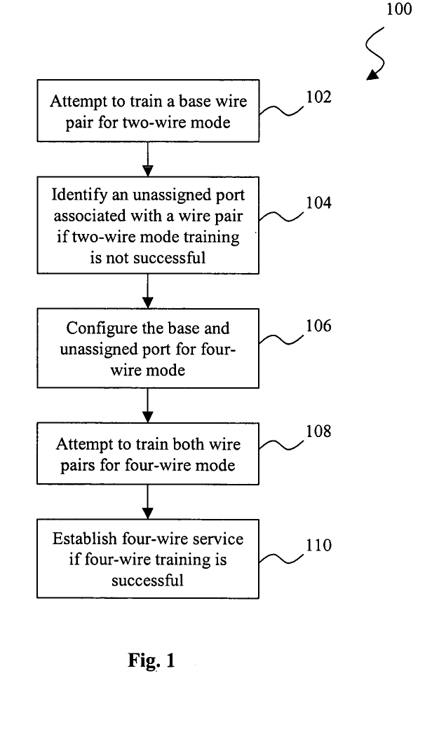

Referring to FIG. 1, in one embodiment, a method 100 enables a system to automatically detect and provision two-wire or four-wire mode. As will be described later in greater detail, the system may include multiple twisted wire pairs that provide a physical connection between one point (e.g., a central office) and one or more other points (e.g., remote ends). Because many wire pairs may extend from the central office, correctly matching the wiring and the provisioning needed for four-wire mode can be a cumbersome and complex task. Automating this task may greatly reduce the time required to deploy services, as well as the skill level of the crafts person deployed to a site.

In step 102, a base wire pair connected between the central office and a remote end is trained for two-wire mode. If the training is successful and the remote end is configured for two-wire mode, services are established using the two-wire mode. If the remote end is configured for four-wire mode the method continues to step 104, where an unassigned port associated with a wire pair is identified. In step 106, the base and unassigned port (and their respective wire pairs) are configured for four-wire mode and, in step 108, an attempt to train them for four-wire mode is made. In step 110, if the four-wire training is successful, service is established using four-wire mode. Accordingly, the method 100 may be used to detect two-wire or four-wire mode automatically.

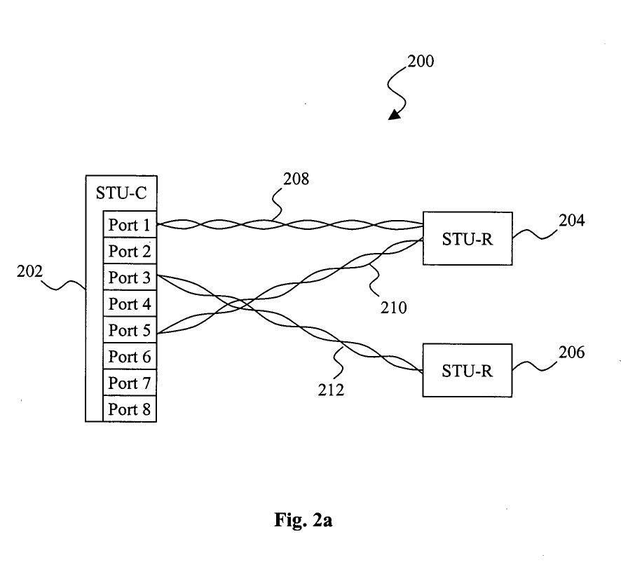

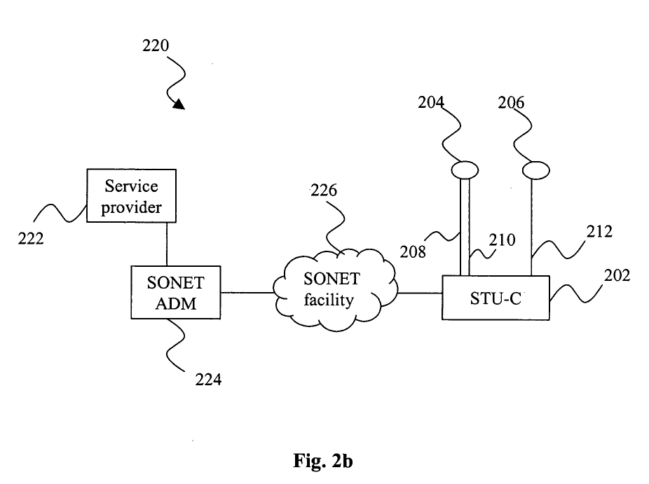

Referring to FIG. 2a, a system 200 illustrates one embodiment of a communications system within which the method of FIG. 1 may be implemented. The system 200 includes an SHDSL Transceiver Unit (STU) 202 located at a central office or another location (an STU-C) connected via an SHDSL facility (represented by twisted wire pairs 208, 210, and 212) to two STUs 204, 206 at remote ends (each of which is designated an STU-R). The STU-C includes eight ports labeled Port 1 through Port 8 that can be connected to an STU-R. In the current example, the STU-C is connected to the STU-R 204 via the twisted wire pairs 208 and 210, and to the STU-R 206 via the twisted wire pair 212.

The SHDSL facility provides a physical connection between the STU-C 202 and the STU-R 204 and STU-R 206, and may be used to carry various services. Depending on the particular STU-R being deployed and the physical configuration and integrity of the twisted copper pairs (e.g., which pair(s) are wired to which port(s)), the line capacity of each of the pairs 208, 210, and 212 may vary. Generally, when in two-wire mode (such as the STU-R 206), the SHDSL line rate is limited to a maximum symmetric rate of 2.3 Mb/s, while in four-wire mode (such as the STU-R 204) the maximum rate can theoretically be doubled to a maximum rate of 4.6 Mb/s.

Software within the system 200 (e.g., within the STU-C), in conjunction with hardware components such as a processor and memory, may automatically detect and provision the SHDSL facility for the desired mode of operation after completing the automatic equipment provisioning depending on the STU-R type and the physical connectivity of the SHDSL line. In some embodiments, the software may also enable pairs in four-wire mode to automatically adapt to a supportable rate.

Referring to FIG. 2b, an exemplary network 220 illustrates one embodiment of an environment within which the system 200 of FIG. 2a may be incorporated. The network 220 includes a service provider 222 that is connected to a plurality of subscriber or remote end devices (e.g., STU-Rs) 204, 206. The service provider 222 may be located at a central office or a similar point of presence that is connected to the network 220 through a device 224, such as a Synchronous Optical Network (SONET) add/drop multiplexer (ADM), which forms part of a SONET network 226. The device 224 is coupled to another device (e.g., an STU-C) 202. The STU-C 202, which may incorporate SONET ADM technology, is operable to separate data intended for the STU-R 204 and STU-R 206 from other data being transported through the SONET network, as well as to add data from the STU-R 204 and STU-R 206 before passing it to the device 224. The STU-C 202 may be coupled to the STU-R 204 and STU-R 206 through cabling such as unshielded twisted pair cabling 208, 210, 212 (e.g., voice grade (CAT 3) cable).

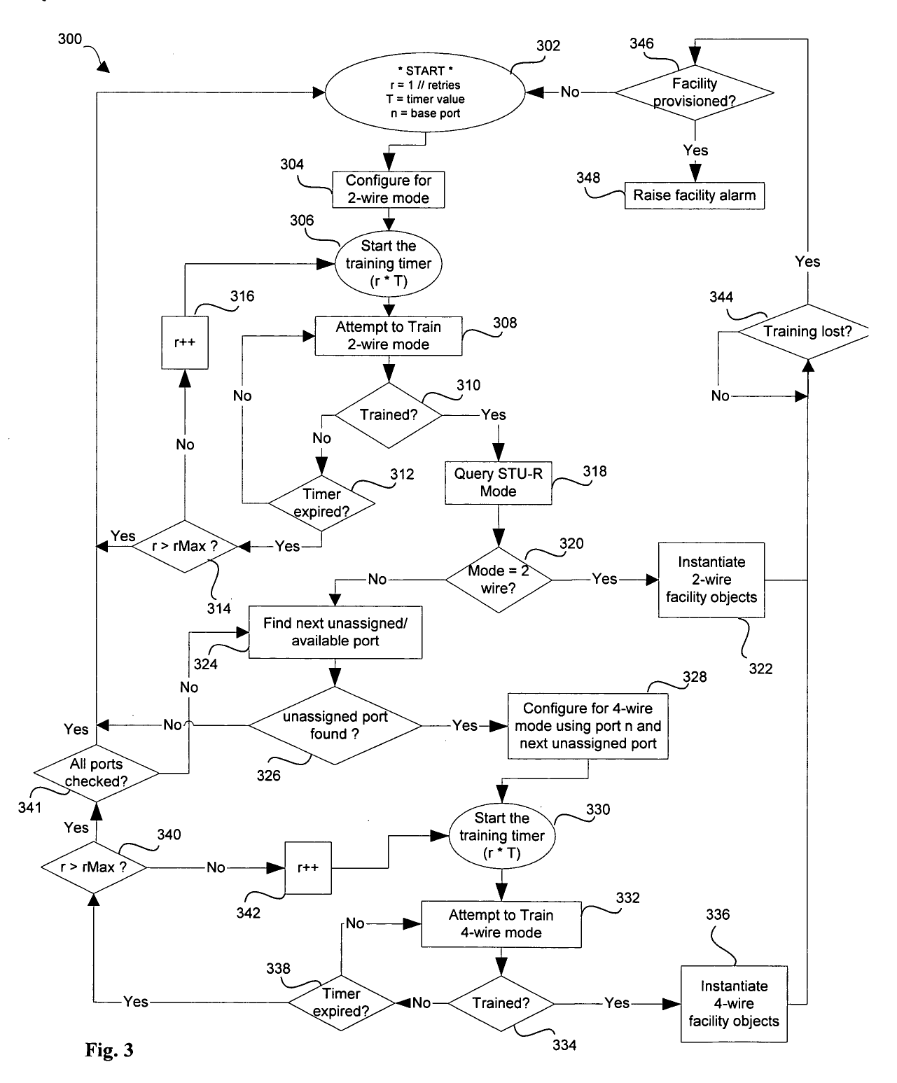

Referring to FIG. 3, in another embodiment, a method 300 may be used to provision a two or four wire line, such as an SHDSL line, in a “plug and play” fashion. The method 300 may be implemented within the system 200 of FIG. 2a using software and/or hardware. In the present example, the STU-C is to be coupled to the STU-R 206 via the twisted pair 212, and then coupled to the STU-R 204 via the twisted pairs 208, 210. Accordingly, the method 300 will first be described with respect to a two-wire mode and then with respect to a four-wire mode.

Generally, when an STU-R is detected, a line should be “trained” so that both ends negotiate to the same speed and quality. The time required for such training varies and could take several minutes. Once trained, the line is ready to carry user traffic at the negotiated rate. In four-wire mode, two physical ports are combined in order to make a single logical channel that carries data interleaved across the two pairs, and the two ports should work together and train as one. As can be seen, if user intervention is required, the crafts person installing the equipment and configuring the node should understand the configuration and follow the correct provisioning procedure in order to properly turn up the facility. The method 300 enables this task to be automated, and the crafts person simply needs to wire up the lines as per the service request and let the method handle the provisioning.

In step 302, the method defines a maximum number of retry values “rMax”, a retry value “r”, a timer value “T”, and a base port “n”. The values “r” and “T” are used to define a training timer having a value of (r*T). The method automatically turns on the physical layer termination devices (PHY's) on all ports of the STU-C 202 and initializes one or more state machines for each port. The method then configures port “n” (e.g., port 3 for the STU-R 206) for two-wire mode in step 304. In step 306, the training timer is started with the value of (r*T). This means that each training period (assuming r>1) will be larger than the previous training period until r>rMax.

In step 308, an attempt is made to train two-wire mode on port n. In step 310, a determination is made as to whether the two-wire mode successfully trained. If the link was not successfully trained (e.g., if it does not successfully negotiate), then the method moves to step 312, where a determination is made as to whether the training timer has expired. If it has not expired, the method returns to step 308 and again attempts to train the pair for two-wire mode. This process may continue until the pair is trained or the timer expires. If the training timer has expired, the method continues to step 314, where a determination is made as to whether “r” is greater than rMax. If it is not greater, the value of “r” is incremented in step 316 and the method returns to step 306, where the training timer is started with the increased value of (r*T). If “r” has exceeded rMax (as determined in step 314), then the method returns to step 302. It is understood that the method may repeat the entire process again, alarm the port, or take other defined actions.

Returning to step 310, if the link was successfully trained (e.g., successfully negotiates), then the method queries the remote end (e.g., the STU-R 206) in step 318 to determine whether the remote end is configured in two-wire mode. If the remote end is configured for two-wire mode (as determined in step 320), then upper layer software is triggered to provision the service by instantiating two-wire facility objects and creating a 2.3 MB/s service on the port in step 322. For example, if port “n” is port 3 of FIG. 2a, then a two-wire mode service will be established via the single twisted wire pair 212 coupling the STU-C 202 to the STU-R 206.

However, if step 320 determines that the remote end is not configured for two-wire mode (e.g., in the case of the STU-R 204), then the method continues to step 324, where an attempt is made to identify an unassigned/available port. If no unassigned port is found (as determined in step 326), the method returns to step 302.

If an unassigned port is found (e.g., port 5 of the STU-C 202 if port n is defined as port 1), the method continues to step 328, where it configures the STU-C 202 for four-wire mode using port “n” and the unassigned port 5. A training timer is then started in step 330 and the method attempts to train the pairs in four-wire mode in step 332. In step 334, a determination is made as to whether the training was successful. If successful, the method moves to step 336, where it instantiates four-wire facility objects and creates a 4.6 MB/s service using the two ports (port “n” and the currently unassigned port 5).

If the link was not successfully trained (as determined in step 334), then the method continues to step 338, where a determination is made as to whether the timer has expired. If not, the method returns to step 332 and attempts to train the pairs for four-wire mode. This process may continue until the pairs are trained or the timer expires.

After the timer expires (assuming the four-wire training failed), the method aborts attempting to train in four-wire mode and continues to step 340, where a determination is made as to whether “r” has exceeded rMax. If it has, the method proceeds to step 341, where a determination is made as to whether any unassigned ports remain to be checked. If no ports remain, then the method returns to step 302. If ports do remain, then the method returns to step 324 to find the next port. If “r” has not exceeded rMax (as determined in step 340), then the value of “r” is incremented in step 342 and the method attempts to find another unassigned port, repeating this process until a port is found that will train four-wire mode successfully or until there are no more unassigned ports. At this point, the method may revert to two-wire mode, repeat the entire process again, alarm the port, or take other defined actions.

If either two-wire mode (step 322) or four-wire mode (step 336) is successful and service is established, the service may continue indefinitely. However, a determination may be made in step 344 as to whether the service has been lost. If not, the step may repeat as shown. If service has been lost, then the method 300 continues to step 346 and determines whether a facility is provisioned for the service. If not, the method returns to step 302 and begins the process described above. If the facility is provisioned, the method continues to step 348 and raises a facility alarm or performs another predefined action.

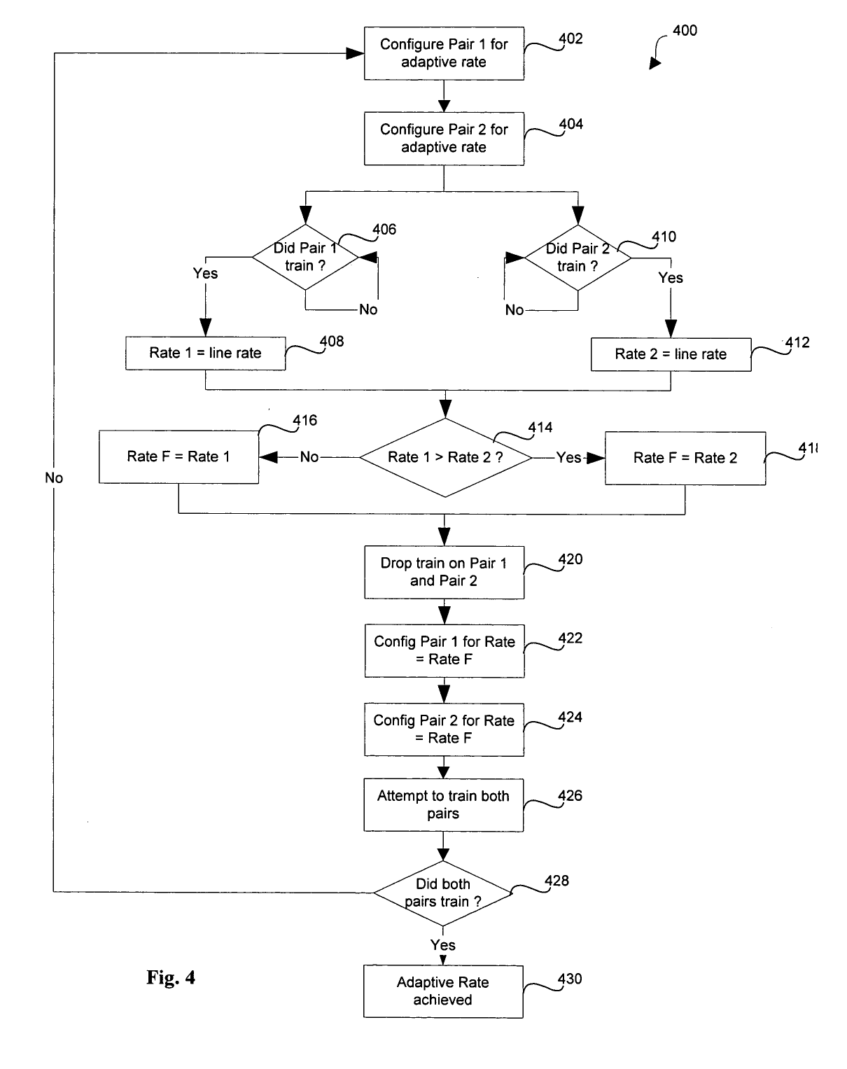

Referring to FIG. 4, a method 400 enables two separate wire pairs to be automatically trained for four-wire mode. As is known, two-wire mode may be either fixed rate or adaptive rate. The adaptive rate enables the wire pair to adjust to variations in line quality and similar issues, and to be trained within a configured signal-to-noise ratio (SNR) margin. Adaptive rates are not supported for four-wire mode. Whether the lines are bit-interleaved, byte-interleaved, or non-interleaved, because the data is interleaved (even in non-interleaved mode), cell delineation may not be achieved if the data is arriving at different speeds on the pairs. Accordingly, a fixed rate is used to ensure that cell delineation can be achieved. The method 400 provides for the use of adaptive rates when training for four-wire mode and may be implemented within the system 200 of FIG. 2a using software and/or hardware.

Using the pairs 208 and 210 of FIG. 2a for purposes of example, the first twisted wire pair 208 and second twisted wire pair 210 are each configured for adaptive rate in steps 402 and 404, respectively. This enables each pair to be treated separately for training purposes. In step 406, a determination is made as to whether the pair 208 successfully trained. If not, an adaptive rate process may be executed until the pair 208 either successfully trains or fails to train at any rate. Once trained, the rate at which the pair 208 successfully trained is identified as its maximum supportable rate in step 408. In step 410, which may occur simultaneously with step 406, a determination is made as to whether the pair 210 successfully trained. If not, step 410 is repeated at lower rates until the pair 210 either successfully trains or fails to train at any rate. Once trained, the rate at which the pair 210 successfully trained is identified as its maximum supportable rate in step 412.

In step 414, the maximum supportable rate for each pair is compared to identify the lower of the rates. If the rate for the first pair is lower, the method continues to step 416, where the first rate is selected as the final rate. If the rate for the second pair is lower, the method continues to step 418, where the second rate is selected as the final rate. In step 420, the training is dropped for both the first pair 208 and second pair 210. In step 422, the first pair is configured to use the final rate as a fixed rate and, in step 424, the second pair is configured to use the final rate as a fixed rate. In step 426, both the first and second pairs are trained in four-wire mode using the fixed rate. A determination is made in step 428 as to whether both pairs successfully trained and, if they did, the adaptively selected rate has been successfully established, as indicated in step 430. If the pairs did not both train, the method may return to step 402 to begin the process again.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. Furthermore, various changes may be made to the methods to conform to various networks and/or protocols. Additionally, various relationships, such as r>rMax, may be altered (e.g., to r=>rMax or r<rMax) and used to perform similar or identical functions. Therefore, the claims should be interpreted in a broad manner, consistent with the present disclosure.

1. A method for automatically sensing and provisioning two or four wire mode for a communications link, the method comprising:
attempting to train a base wire pair associated with a base port for two-wire mode;
identifying a first unassigned port associated with a first wire pair if the two-wire mode training is unsuccessful;
configuring the base and first ports for four-wire mode;
attempting to train the base and first wire pairs for four-wire mode; and
establishing a four-wire service using the base and first wire pairs if the four-wire mode training is successful.

2. The method of claim 1 further comprising:
identifying a second unassigned port associated with a second wire pair if the four-wire mode training of the base and first wire pairs is unsuccessful;
attempting to train for four-wire mode using the base and second ports; and
establishing a four-wire service using the base and second ports if the four-wire mode training is successful.

3. The method of claim 1 further comprising establishing a two-wire service using the base wire pair if the two-wire mode training is successful.

4. The method of claim 1 wherein the communications link includes a symmetric high-speed digital subscriber line (SHDSL) interface.

5. A method for adaptive rate training in four-wire mode for a communications link, the method comprising:
configuring first and second wire pairs for adaptive rates;
training the first and second wire pairs to identify a maximum supportable rate for each pair; and
configuring each of the first and second wire pairs for a fixed rate equal to the lower of the identified maximum supportable rates.

6. The method of claim 5 further comprising attempting to train the first and second wire pairs using the fixed rate.

7. The method of claim 6 further comprising:
reconfiguring the first and second wire pairs for adaptive rates if the training at the fixed rate fails on either of the first or second pairs; and
retraining the first and second wire pairs to determine a new maximum supportable rate for each of the first and second wire pairs.

8. The method of claim 7 wherein an adaptive rate process is executed to perform the reconfiguring and retraining until the training is successful or there are no more supportable rates to try.

9. A device configured to automatically provision a link between the device and a remote end device in two-wire or four wire mode, the device comprising:
a plurality of ports configured to couple the device to at least the remote end device via one or more wire pairs;
a processor controlling the plurality of ports;
a memory accessible to the processor for storing a plurality of instructions for execution by the processor, the instructions including:
instructions for configuring a first port of the plurality of ports for two-wire mode, wherein the first port is coupled to the remote end device via a first wire pair;
instructions for attempting to train the first wire pair for two-wire mode;
instructions for identifying an unassigned second port of the plurality of ports if the two-wire mode training is unsuccessful, wherein the second port is coupled to the remote end device via a second wire pair;
instructions for configuring the first and second ports for four-wire mode;
instructions for attempting to train the first and second wire pairs for four-wire mode; and
instructions for establishing a four-wire service using the first and second wire pairs if the four-wire mode training is successful.

10. The device of claim 9 further comprising:
instructions for identifying an unassigned third port of the plurality of ports associated with a third wire pair if the four-wire mode training of the first and second wire pairs is unsuccessful;
instructions for attempting to train for four-wire mode using the first and third ports; and
instructions for establishing a four-wire service using the first and third ports if the four-wire mode training is successful.

11. The device of claim 9 further comprising instructions for establishing a two-wire service using the first wire pair if the two-wire mode training is successful.

12. The device of claim 9 wherein the link includes a symmetric high-speed digital subscriber line (SHDSL) interface.

13. A system for automatically provisioning a link in two-wire or four wire mode, the device comprising:
a first device at a remote end;
a second device that includes one or more twisted wire pairs coupling at least one of a plurality of ports on the second device to the first device via a symmetric high-speed digital subscriber line (SHDSL) facility; and
a plurality of instructions accessible to the second device, the instructions including:
instructions for attempting to train a first wire pair associated with a first of the plurality of ports for two-wire mode, wherein the first wire pair is coupled to the remote end device;
instructions for identifying an unassigned second port of the plurality of ports associated with a second wire pair if the two-wire mode training is unsuccessful, wherein the second wire pair is coupled to the remote end device;
instructions for configuring the first and second ports for four-wire mode;
instructions for attempting to train the first and second wire pairs for four-wire mode; and
instructions for establishing a four-wire service using the first and second wire pairs if the four-wire mode training is successful.

14. The system of claim 13 further comprising:
instructions for identifying an unassigned third port of the plurality of ports associated with a third wire pair if the four-wire mode training of the first and second wire pairs is unsuccessful;
instructions for attempting to train for four-wire mode using the first and third ports; and
instructions for establishing a four-wire service using the first and third ports if the four-wire mode training is successful.

15. The system of claim 13 further comprising instructions for:
configuring the first and second wire pairs for adaptive rates;
training the first and second wire pairs to identify a maximum supportable rate for each pair; and
configuring each of the first and second wire pairs for a fixed rate equal to the lower of the identified maximum supportable rates.
